(19) United States
(12) Patent Application Publication
(10) Pub. No.: US 2026/0067711 A1
(43) Pub. Date: Mar. 5, 2026

(54) MITIGATING TIME OF FLIGHT INTERFERENCE USING CODEBOOK SUBSET RESTRICTIONS

(71) Applicant: T-MOBILE INNOVATIONS LLC, Overland Park, KS (US)

(72) Inventors: Roopesh Kumar POLAGANGA, Bothell, WA (US); Amembal Vikram PAI, Bothell, WA (US); Ramesh Venkata JOSYULA, Redmond, WA (US)

(21) Appl. No.: 18/823,076

(22) Filed: Sep. 3, 2024

(51) Int. Cl. H04W 16/28; H04B 7/06; H04W 24/02

(52) U.S. Cl. CPC H04W 16/28; H04B 7/0669; H04W 24/02

(57) ABSTRACT

Methods and systems for detecting and mitigating the effects of time of flight interference of a radio frequency (RF) signal are provided. A wireless communication network may determine that time of flight interference is occurring based on the undesirable propagation of an aggressor base station's downlink signals into a victim base station's coverage area. In response to the determination, the network may implement codebook subset restrictions at the aggressor base station, preventing downlink signals from being transmitted along paths that can be undesirably propagated to the victim base station.

### SUMMARY

The present disclosure is directed to mitigating time of flight interference, particularly caused by tropospheric ducting, using codebook subset restrictions, substantially as shown and/or described in connection with at least one of the Figures, and as set forth more completely in the claims.

According to various aspects of the technology, a set of one or more precoding matrices of a codebook will be restricted in order to prevent signals from being transmitted from a base station along an elevation or azimuth that would otherwise cause of time of flight interference to a different cell. Meteorological events such as a tropospheric duct, or geographic features such as bodies of water, often affect the propagation of signals by reflecting or refracting them in unintended directions or for distances much greater than anticipated or intended. Consequently, a wireless communication device not intended to be in communication with a first base station may receive signals from the first base station, causing interference with respect to signals received by the device from a second base station, with which the device intends to/should communicate. By implementing codebook subset restrictions that prevent the use of certain precoding matrices, signals will not be transmitted from an aggressor base station in directions that will propagate to a victim cell's coverage area, mitigating or eliminating time of flight interference attributable to the aggressor base station.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present technology is described in detail herein with reference to the drawing figures, which are intended to be exemplary and non-limiting in nature, wherein:

FIG. 1 depicts an exemplary computing environment suitable for use in implementation of the present disclosure;

FIG. 2 illustrates a diagram of an exemplary network environment in which implementations of the present disclosure may be employed;

FIGS. 3A-3B each depict a graphical representation of a plurality of base stations and vertical cross sections of beamforms produced by antennas thereon with respect to atmospheric-based ducting, in accordance with an embodiment of the present technology

FIG. 4 illustrates a codebook subset restriction map, suitable for use with the present disclosure; and

FIG. 5 depicts a block diagram of an exemplary method of mitigating the effects of a meteorological event on the propagation of an RF signal, in accordance with an embodiment of the present technology.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies suitable for use with the present disclosure include but are not limited to 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Additionally, as used in this disclosure, “ducting” or “time of flight interference” describe a meteorological- or geographical-caused RF phenomenon that causes or results in a RF signal being propagated, reflected, or refracted differently than intended by an emitting source. For example, when a RF signal is intended to provide wireless service for wireless communication devices within a 5 mile radius, but due to an atmospheric boundary layer or body of water, the RF signal is propagated for 50 miles, ducting is occurring, causing time of flight interference in the area 50 miles from the emitter. A “mobile device,” as used herein, is a device that has the capability of using a wireless communications network, and may also be referred to as a “user device,” “wireless communication device,” or “user equipment (UE).” A mobile device may take on a variety of forms, such as a personal computer (PC), a laptop computer, a tablet, a mobile phone, a personal digital assistant (PDA), a server, or any other device that is capable of communicating with other devices using a wireless communications network. Additionally, embodiments of the present technology may be used with different technologies or standards, including, but not limited to, CDMA 1×A, GPRS, EvDO, TDMA, GSM, WiMax technology, LTE, and/or LTE Advanced, among other technologies and standards.

By way of background, time of flight interference is a phenomenon of the radio frequency environment in which signals propagate further than intended, causing interference with a remote station on a same or similar frequency. One common cause of time of flight interference that effects telecommunication networks is tropospheric ducting. Tropospheric ducting occurs when there is an abnormal temperature inversion or a significant increase in humidity within the troposphere, causing the refractive index of the atmosphere to change in such a way that radio waves are trapped and guided over long distances. Normally, radio waves travel in straight lines and can bend slightly due to the curvature of the Earth, but during tropospheric ducting, these waves are confined within a “duct” formed by the temperature inversion, allowing them to propagate much farther than usual. In the context of mobile telecommunications, this phenomenon can lead to unintended long-distance propagation of signals, causing co-channel interference where signals from distant transmitters overlap with local signals on the same frequency. This can degrade quality of service, result in dropped calls, and create challenges in maintaining stable connections, as the network may struggle to manage the unexpected influx of signals from outside its intended coverage area.

Conventionally, time of flight interference is mitigated, if at all, by physically adjusting base station antennas (e.g., down-tilt), shutting down cells, or modifying the coverage area of a particular base station by manually controlling beamforming procedures. Unlike conventional solutions, the present disclosure is directed to the use of codebook subset restrictions (CBSR) to mitigate time of flight interference. By using CBSR, a mobile network operator can more quickly and more granularly control the negative impacts to the network that result from modifying coverage areas. Additionally, using CBSR as a solution to mitigating time of flight interference decreases the time needed to return a cell to normal operations once the time of flight event (e.g., a tropospheric duct) concludes.

Accordingly, a first aspect of the present disclosure is directed to a system for mitigating time of flight interference in a wireless telecommunication environment. The system comprises a first base station configured to transmit downlink signals to a first coverage area using a plurality of antennas. The system further comprises one or more computer processing components configured to perform operations for mitigating the time of flight interference. The operations comprise determining that a first base station is causing time of flight interference in a second coverage area served by a second base station. The operations further comprise, based on said determination, communicating a codebook subset restriction (CBSR) to a user equipment (UE) served by the first base station that comprises one or more restricted precoding matrix indicators (PMIs), wherein communicating the CBSR causes the UE to select an unrestricted PMI.

Another aspect of the present disclosure is directed to method for mitigating time of flight interference in a wireless telecommunication environment. The method comprises determining that a first base station is causing time of flight interference in a second coverage area served by a second base station. The method further comprises, based on said determination, communicating a codebook subset restriction (CBSR) to a user equipment (UE) served by the first base station that comprises one or more restricted precoding matrix indicators (PMIs), wherein communicating the CBSR causes the UE to select an unrestricted PMI.

Another aspect of the present disclosure is directed to one or more non-transitory computer-readable media having computer-executable instructions embodied thereon that, when executed, perform a method for mitigating time of flight interference in a wireless telecommunication environment. The method comprises determining that a first base station is causing time of flight interference in a second coverage area served by a second base station. The method further comprises, based on said determination, communicating a codebook subset restriction (CBSR) to a user equipment (UE) served by the first base station that comprises one or more restricted precoding matrix indicators (PMIs), wherein communicating the CBSR causes the UE to select an unrestricted PMI.

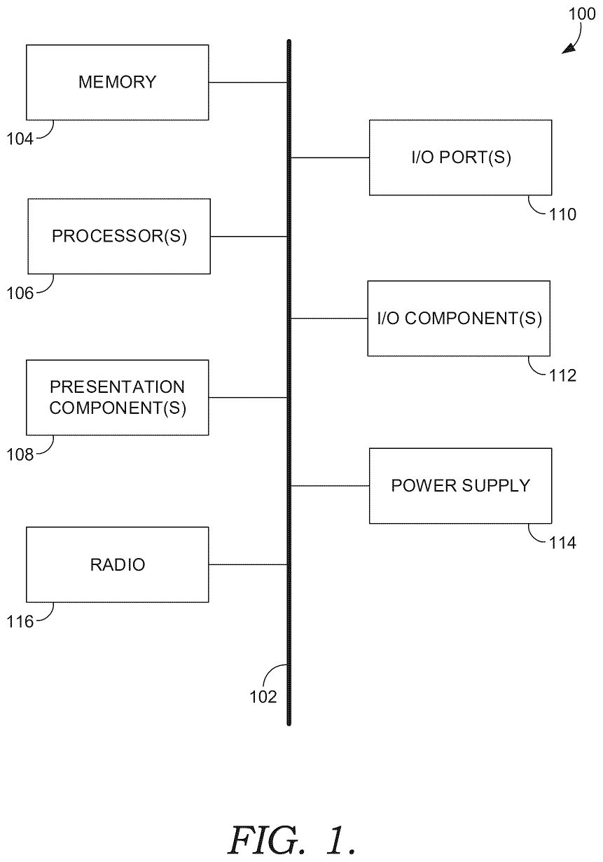

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A radio 116 represent radios that facilitate communication with one or more wireless networks using one or more wireless links. In aspects, the radio 116 utilizes a transmitter to communicate with a wireless network on. Though a single radio is shown, it is expressly conceived that a computing device with more than one could facilitate communication over one or more wireless links with one or more wireless networks via both a first transmitter and a second transmitter. Illustrative wireless telecommunications technologies include CDMA, GPRS, TDMA, GSM, 802.11, and the like. The radio 116 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the radio 116 may be configured to communicate using the same protocol but in other aspects they may be configured to communicate using different protocols. In some embodiments, including those that both radios or both wireless links are configured for communicating using the same protocol, the radio 116 may be configured to communicate on distinct frequencies or frequency bands (e.g., as part of a carrier aggregation scheme). As can be appreciated, in various embodiments, the radio 116 can be configured to support multiple technologies and/or multiple frequencies; for example, including cellular communication protocols (e.g., 4G, 5G, 6G, or the like), or non-cellular communication protocols (e.g., IEEE 802.11 series, Bluetooth, NFC, z-wave, or the like).

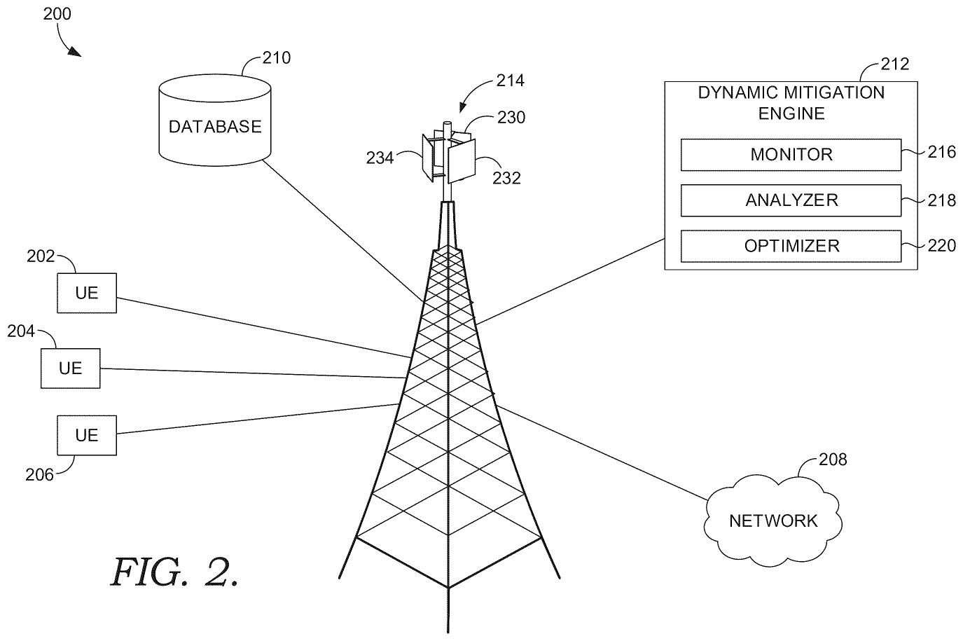

FIG. 2 provides an exemplary network environment in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated. Network environment 200 includes one or more user devices (e.g., user devices 202, 204, and 206), base station 214, network 208, database 210, and dynamic meteorological mitigation engine 212.

In some aspects, the user devices 202, 204, and 206 correspond to computing device 100 in FIG. 1. Thus, a user device may include, for example, a display(s), a power source(s) (e.g., a battery), a data store(s), a speaker(s), memory, a buffer(s), a radio(s) and the like. In some implementations, the user devices 202, 204, and 206 comprises a wireless or mobile device with which a wireless telecommunication network(s) may be utilized for communication (e.g., voice and/or data communication). In this regard, the user device may be any mobile computing device that communicates by way of a wireless network, for example, a 3G, 4G, 5G, LTE, CDMA, or any other type of network.

In some cases, the user devices 202, 204, and 206 in network environment 200 may optionally utilize network 208 to communicate with other computing devices (e.g., a mobile device(s), a server(s), a personal computer(s), etc.) through base station 214. The network 208 may be a telecommunications network(s), or a portion thereof. A telecommunications network might include an array of devices or components (e.g., one or more base stations), some of which are not shown. Those devices or components may form network environments similar to what is shown in FIG. 2, and may also perform methods in accordance with the present disclosure. Components such as terminals, links, and nodes (as well as other components) may provide connectivity in various implementations. Network 208 may include multiple networks, as well as being a network of networks, but is shown in more simple form so as to not obscure other aspects of the present disclosure.

Network 208 may be part of a telecommunication network that connects subscribers to their service provider. In aspects, the service provider may be a telecommunications service provider, an internet service provider, or any other similar service provider that provides at least one of voice telecommunications and data services to any or all of the user devices 202, 204, and 206. For example, network 208 may be associated with a telecommunications provider that provides services (e.g., LTE) to the user devices 202, 204, and 206. Additionally or alternatively, network 208 may provide voice, SMS, and/or data services to user devices or corresponding users that are registered or subscribed to utilize the services provided by a telecommunications provider. Network 208 may comprise any communication network providing voice, SMS, and/or data service(s), using any one or more communication protocols, such as a 1× circuit voice, a 3G network (e.g., CDMA, CDMA2000, WCDMA, GSM, UMTS), a 4G network (WiMAX, LTE, HSDPA), or a 5G network. The network 208 may also be, in whole or in part, or have characteristics of, a self-optimizing network.

In some implementations, base station 214 is configured to communicate with the user devices 202, 204, and 206 that are located within the geographical area defined by a transmission range and/or receiving range of the radio antennas of base station 214. The geographical area may be referred to as the “coverage area” of the cell site or simply the “cell,” as used interchangeably hereinafter. Base station 214 may include one or more radios, antennas, antenna arrays, power amplifiers, transmitters/receivers, digital signal processors, control electronics, GPS equipment, and the like. In particular, base station 214 may be configured to wirelessly communicate with devices within a defined and limited coverage area. For the purposes of the present disclosure, it may be assumed that it is undesirable and unintended by the network 208 that any base station other than base station 214 provide wireless connectivity to the user devices 202, 204, and 206 while the user devices 202, 204, and 206 are geographically situated in the service area of base station 214. Because the base station 214 is the intended base station for the user devices 202, 204, and 206, it may be referred to herein as the victim base station when time of flight interference is determined to exist within the coverage area of the base station 214, wherein the source of the downlink signal that causes the time of flight interference is from a distant base station (referred to herein as an aggressor base station).

As shown, base station 214 is in communication with dynamic mitigation engine 212, which comprises various components that are utilized, in various implementations, to perform one or more methods for determining that time of flight interference is occurring within base station 214's coverage area and implementing one or more mitigation measures. In some implementations, dynamic mitigation engine 212 comprises components including a monitor 216, an analyzer 218, and an optimizer 220. However, in other implementations, more or less components than those shown in FIG. 2 may be utilized to carry out aspects of the invention described herein. The components of dynamic mitigation engine 212 may take any one or more of many forms, but specifically may comprise one or more processors and/or servers configured to perform the functions described herein.

The monitor 216 of the dynamic mitigation engine 212 is generally responsible for monitoring information that may be relevant to making a determination that time of flight interference is taking place within the coverage area of base station 214 and for determining when ducting mitigation measures can be restored. In aspects, the monitor 216 may determine that time of flight interference is taking place based on meteorological data, dropped calls, or other reductions in one or more key performance indicators (KPIs) in a coverage area associated with the base station 214. In other aspects, the monitor 216 may determine that time of flight interference is taking place based on a determination that an interference level (e.g., noise, SINR, etc.) is greater than a predetermined threshold, particularly during an uplink time block in which the base station 214 is scheduled to receive signals from the one or more UEs, such as UEs 202-206. In yet other aspects, the monitor 216 may determine that time of flight interference is occurring based on a downward slope of observed interference during the uplink time block; that is, the monitor 216 may determine interference has decreased from a first level at a first time of the uplink time block (i.e., series of consecutive uplink slots or symbols) to a second level at a second time of the uplink time block. Such an indication may be caused by the downlink transmissions of distant aggressor base stations decreasing as those aggressor base stations switch from downlink transmissions to guard periods and uplink blocks. The monitor 216 is further configured to communicate the indication that time of flight interference is occurring to the analyzer 218.

The analyzer 218 is generally responsible for identifying the aggressor base station. The analyzer 218 receives the one or more time of flight interference parameters from the monitor 216 at an operator-defined frequency during an operator-defined sampling period; for example, the analyzer 218 may receive a value associated with each of the one or more time of flight interference parameters every minute during a 15 minute reporting output period (ROP). The analyzer 218 may identify an aggressor base station based on historical instances of time of flight interference, in which it was observed that taking mitigating steps at an aggressor base station reduced the time of flight interference observed at the base station 214. In other aspects, an aggressor base station may be identified based on the aggressor base station being coaxial with a line of bearing on which interference is detected at the base station 214. In other instances, the analyzer may utilize tropospheric ducting forecasts to identify candidate aggressor base stations, particularly based on the direction of their transmissions and their radiation height.

The optimizer 220 is generally configured to implement one or more time of flight mitigation measures. The present disclosure uses codebook subset restrictions (CBSR) to mitigate the time of flight interference. A codebook in the context of wireless communications is a predefined set of precoding matrices that dictates how transmitted signals are spatially processed across multiple antennas. Each precoding matrix in the codebook represents a specific combination of phase and amplitude adjustments applied to the signals transmitted from different antennas. Each precoding matrix is associated with a Precoding Matrix Indicator (PMI) which is used by the UE to select/rank its preferred precoding matrices from the codebook, based on observations and measurements of synchronization or other signaling (e.g., channel state information reference signals (CSI-RS)). A Codebook Subset Restriction (CBSR) is a mechanism by which the network restricts the UE to a subset of the full codebook. This restriction is communicated by the base station and instructs the UE to ignore certain precoding matrices, effectively limiting the UE's options for PMI selection.

The optimizer 220 may implement CBSR in different ways. In a first aspect, the optimizer 220 may determine that a set of PMIs should be restricted (and therefore ignored by the UE) based on a determination that the set of PMIs correspond to downlink signals transmitted within a threshold azimuth range of a line of bearing to the victim base station 214. For example, if the aggressor base station is due west of the victim base station 214, then the optimizer may implement CBSR by restricting PMIs that correspond to downlink signals transmitted by the aggressor base station within 5, 10, or 15 degrees (or more or less) of 90 degrees (due east). In another aspect, the optimizer 220 may additionally or alternatively determine that a set of PMIs should be restricted based on the elevation of the transmitted signal to which the PMI corresponds. For example, the optimizer 220 may restrict PMIs that correspond to signals transmitted at greater than 0, −5, or +5 degrees of a horizontal plane that is parallel with the ground (one skilled in the art will appreciate that many other ranges of elevation may be used based on the discretion of a mobile network operator as they balance the tradeoff between mitigating time of flight interference and sacrificing coverage area). The optimizer 220 may also implement an iterative approach, wherein a first CBSR is implemented by an aggressor base station, interference levels are measured at the victim base station 214, and then a second set of CBSR is implemented by the aggressor base station based a determination that the interference level measured at the second base station has reduced from a first level to a second level, but that the second level is still greater than a predetermined threshold. Using the iterative approach, the optimizer 220 may increase the CBSR by adding more PMIs to the restricted set that correspond to increasing azimuths and/or elevations. Finally, the optimizer 220 may be configured to instruct an aggressor base station to cease CBSR and restore to a normal/default operating mode after a predetermined amount of time (e.g., one hour, 12 hours, 24 hours) has elapsed.

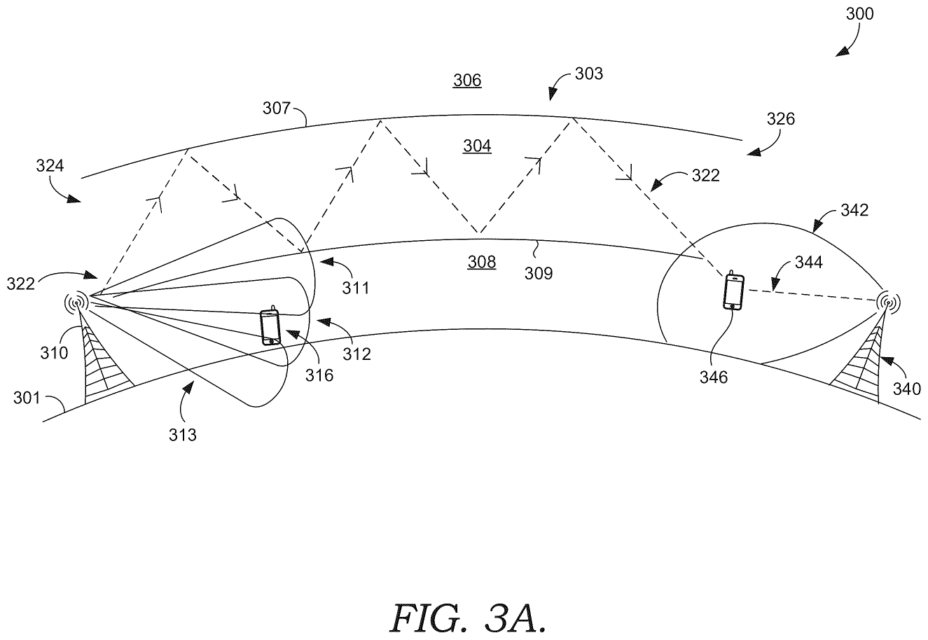

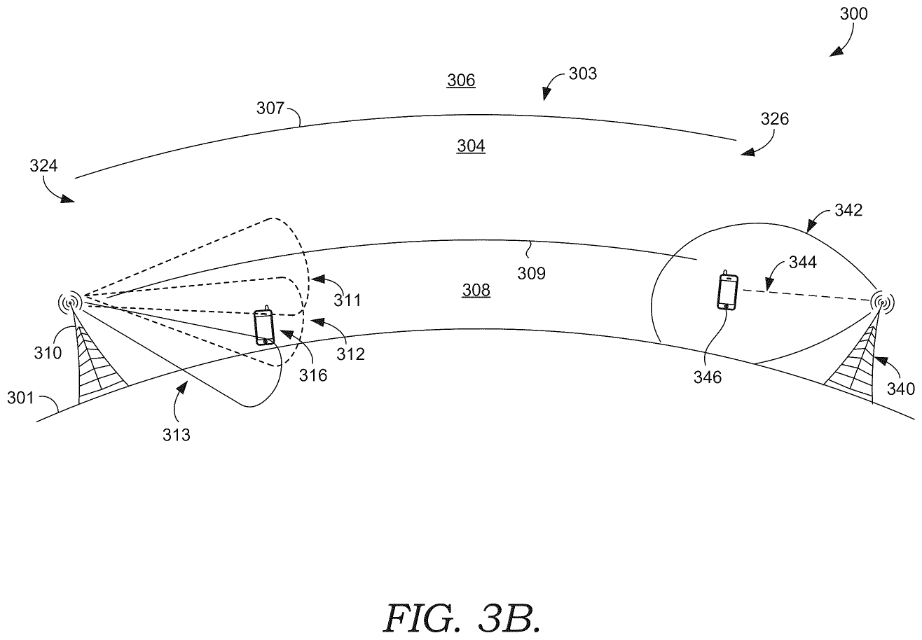

Turning now to FIG. 3A, an example of the present disclosure is illustrated. The representative system 300 comprises a first base station 310, a second base station 340, and a plurality of user devices. The system 300 comprises a meteorological condition 303 occurring or proximate to the first base station 310, wherein the first base station 310 provides coverage for a plurality of user devices. In the illustrated aspect, the meteorological condition 303 is a tropospheric duct, that is, a first air mass 306 and a third air mass 308 are cooler (e.g., temperature) and/or dryer (e.g., humidity characteristics) than a second air mass 304, wherein the second air mass 304 is disposed between the first air mass 306 and the third air mass 308. Though a tropospheric duct 303 may be formed in several ways, the meteorological condition is common when an air mass located at a first elevation measured from the earth's surface or the ground level 301 cools faster than another air mass located at a second, higher elevation measured from the ground level 301. Though the boundaries may not be rigidly defined, the tropospheric duct may be said to generally be defined by a first boundary layer 307 separating the first air mass 306 from the second air mass 304 and a second boundary layer 309 separating the second air mass 304 from the third air mass 308. For the purposes of the present disclosure, the tropospheric duct 303 may also be said to define an entrance 324 and an exit 326, wherein the entrance 324 and the exit 326 represent the horizontal extent of the tropospheric duct 303 and are defined with respect to the tropospheric duct 303 and its impact on an RF signal emitted from the first base station 310.

Operating without any CBSR, the first base station 310 may transmit a plurality of different signals to a first UE 316, allowing the first UE 316 to select/rank which precoding matrix corresponds to the best observed signal. In the illustrated example, the first base station 310 may transmit using a codebook having three different precoding matrices, wherein each precoding matrix corresponds to a first beam 311, a second beam 312, and a third beam 313. The first UE 316 may observe the best signal parameters with the second beam 312, followed by the first beam 311 and then the third beam 313. Unfortunately, because the entrance 324 of the tropospheric duct 303 overlaps with the first beam 311 and the second beam 312, portions of the signals 322 from said beams will enter the tropospheric duct and will propagate to the second base station 340's coverage area. If those portions of the signals 322 reach the second base station 340's coverage area during an uplink time slot/symbol of the second base station 340, it can cause interference to a wireless link 344 between a second UE 346 and the second base station 340.

Turning now to FIG. 3B, the system 300 of FIG. 3A is illustrated with the implementation of CBSR described herein. Based on a determination that the first base station 310 is causing time of flight interference against the second base station 340, one or more CBSR measures will be implemented. In the simplified aspect illustrated in FIGS. 3A-3B which focuses on a vertical cross section of a radio environment, it may be seen that an elevation-based CBSR measure is implemented, wherein precoding matrices having precoding matrix indicators that correspond to the first beam 311 and the second beam 312 may be restricted because they have an elevation that includes an elevation equal to or greater than 0 degrees relative to a horizontal plane parallel with the ground level 301. In other words, because no portion of the third beam is transmitted parallel to the ground or greater, no portion of the third beam will enter the tropospheric duct 303. Accordingly, the first base station will communicate a CBSR instruction to the first UE 316 that indicates that a first precoding matrix indicator corresponding to the first beam 311 and a second precoding matrix indicator corresponding to the second beam 312 are restricted. Communicating the CBSR instruction to the first UE 316 causes the first UE 316 to ignore the first and second precoding matrices for the purposes of ranking its best candidate precoding matrices. In the simplified illustration provided, the first UE 316 would, accordingly, communicate its preference to the first base station 310 to utilize a precoding matrix corresponding to the third beam 313. The first base station 310 would then utilize said precoding matrix, which will prevent it from transmitting signals into the entrance 324 of the tropospheric duct 303, eliminating the time of flight interference that the first base station 310 created at the second base station 340 in FIG. 3A.

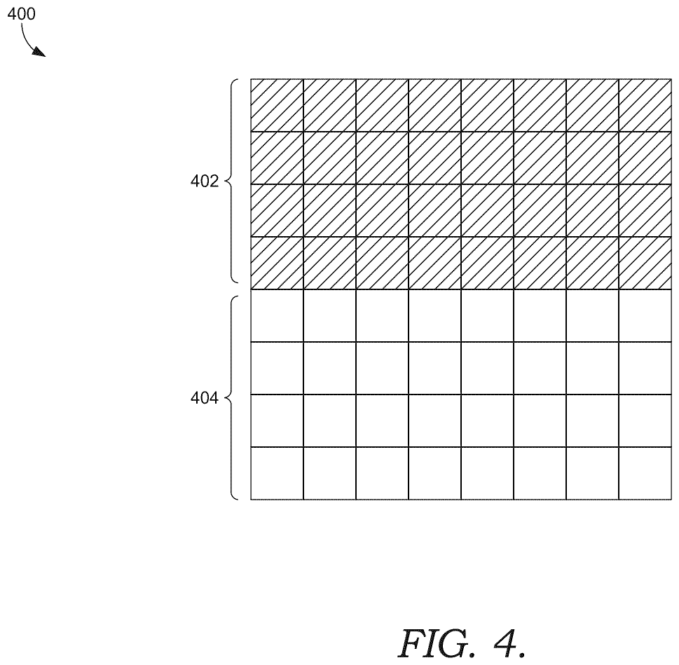

FIG. 4 illustrates a simplified codebook 400 used by a base station, such as the base station 310 of FIGS. 3A-3B to transmit signals to a coverage area. Illustrated as a vertical cross-section near the transmitter of the base station, each grid point of the 8×8 grid represents possible directions in space (azimuth and elevation, with a boresight in the center of the grid) that a signal could be transmitted. Each grid point, then, may correspond to one or more precoding matrices that are used to transmit signals to/through that said grid point. In order to effectuate the codebook subset restrictions described with respect to FIGS. 2-3B, the codebook 400 may be said to comprise a first set of precoding matrices 402 that are restricted and a second set of precoding matrices 404 that are unrestricted. In the illustrated embodiment, if the boresight was oriented parallel to the ground, then the first set of precoding matrices 402 have an elevation equal to or greater than zero degrees (relative to the parallel-to-ground plane); whereas, the second set of precoding matrices 404 have an elevation less than zero degrees. By communicating the CBSR instruction to a UE, the UE will not be permitted to select/rank precoding matrices of the first set of precoding matrices 402; if downlink signals corresponding to the second set of precoding matrices 404 avoid entering a tropospheric duct when transmitted by the base station, then the UE may continue to be served by the base station without the base station causing time of flight interference due to signals propagating through the tropospheric duct to a distant victim base station. Though illustrated as an elevation-only restriction in FIG. 4, it is expressly conceived that any pattern of precoding matrix restrictions could be implemented, including those based on azimuth, elevation, or a combination thereof.

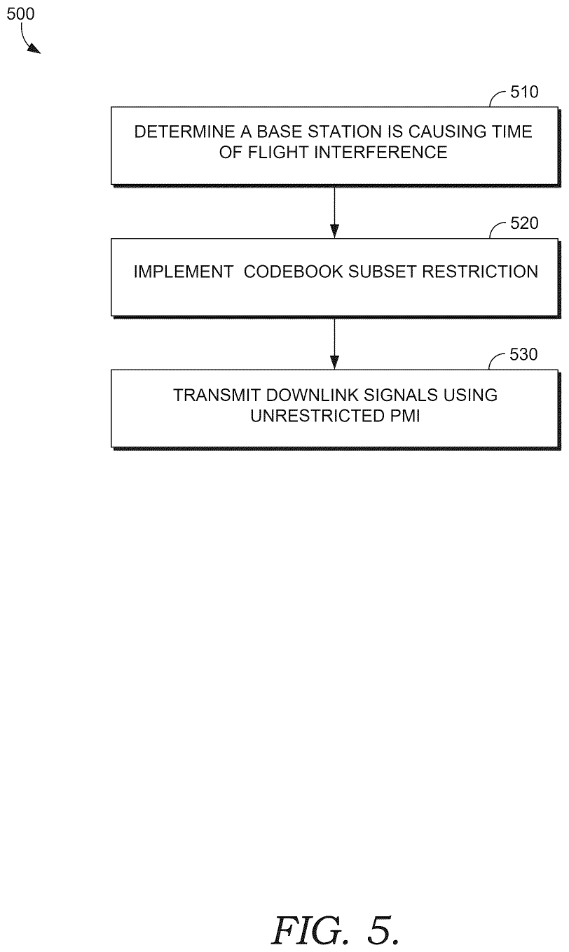

Turning now to FIG. 5, a representative method 500 is provided. At a first step 510, it is determined that a first base station is causing time of flight interference in a second coverage area served by a second base station, according to one or more aspects described herein with respect to FIGS. 2-3B. At a second step 520, one or more codebook subset restrictions are communicated to a user equipment (UE) based on the determination at step 510, the codebook subset restriction comprising one or more restricted precoding matrix indicators (PMIs), wherein communicating the CBSR causes the UE to select an unrestricted PMI, according to any one or more aspects described herein with respect to FIGS. 2-4. In aspects, the method 500 comprises a third step 530, wherein a set of downlink signals are subsequently communicated with the UE using the unrestricted PMI, according to any one or more aspects described herein.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for mitigating time of flight interference in a wireless telecommunication environment comprising:
a first base station configured to transmit downlink signals to a first coverage area using a plurality of antennas; and
one or more computer processing components configured to perform operations comprising:
determining that a first base station is causing time of flight interference in a second coverage area served by a second base station; and
based on said determination, communicating a codebook subset restriction (CBSR) to a user equipment (UE) served by the first base station that comprises one or more restricted precoding matrix indicators (PMIs), wherein communicating the CBSR causes the UE to select an unrestricted PMI.

2. The system of claim 1, wherein the operations further comprise receiving, from the UE, a ranked list of PMIs, the ranked list of PMIs not comprising the one or more restricted PMIs.

3. The system of claim 2, wherein determining that the first base station is causing time of flight interference is based on an interference level measured at the second base station being greater than a predetermined threshold.

4. The system of claim 3, wherein the interference level is measured during a series of uplink slots of the second base station.

5. The system of claim 4, wherein the interference level has a first value at a first time in the series of uplink slots and a second value at a second time in the series of uplink slots, the first value being greater than the second value and the first time being before the second time.

6. The system of claim 2, wherein the one or more restricted PMIs are within a predetermined azimuth of a line of bearing between the first base station and the second base station.

7. The system of claim 6, wherein the one or more restricted PMIs correspond to downlink signals transmitted along an axis having an elevation greater than a first elevation limit.

8. The system of claim 7, wherein the operations further comprise communicating a second CBSR to the UE comprising a second set of restricted PMIs based a determination that an interference level measured at the second base station has reduced from a first level to a second level, the second level being greater than a predetermined threshold, and wherein the second set of restricted PMIs correspond to downlink signals transmitted along an axis having an elevation greater than a second elevation limit, the second elevation limit being angled nearer to the ground than the first elevation limit.

9. The system of claim 8, wherein the operations further ceasing to communicate the CBSR to the UE after a predetermined amount of time.

10. A method for mitigating time of flight interference in a wireless telecommunication environment, the method comprising:
determining that a first base station is causing time of flight interference in a second coverage area served by a second base station; and
based on said determination, communicating a codebook subset restriction (CBSR) to a user equipment (UE) served by the first base station that comprises one or more restricted precoding matrix indicators (PMIs), wherein communicating the CBSR causes the UE to select an unrestricted PMI.

11. The method of claim 10, wherein determining that the first base station is causing time of flight interference is based on an interference level measured at the second base station being greater than a predetermined threshold during a series of uplink slots of the second base station.

12. The method of claim 11, wherein the interference level has a first value at a first time in the series of uplink slots and a second value at a second time in the series of uplink slots, the first value being greater than the second value and the first time being before the second time.

13. The method of claim 12, wherein the one or more restricted PMIs are within a predetermined azimuth of a line of bearing between the first base station and the second base station.

14. The method of claim 13, wherein the one or more restricted PMIs correspond to downlink signals transmitted along an axis having an elevation greater than a first elevation limit.

15. The method of claim 14, wherein the operations further comprise communicating a second CBSR to the UE comprising a second set of restricted PMIs based a determination that an interference level measured at the second base station has reduced from a first level to a second level, the second level being greater than a predetermined threshold, and wherein the second set of restricted PMIs correspond to downlink signals transmitted along an axis having an elevation greater than a second elevation limit, the second elevation limit being angled nearer to the ground than the first elevation limit.

16. One or more non-transitory computer-readable media having computer-executable instructions embodied thereon that, when executed, perform a method for mitigating time of flight interference in a wireless telecommunication environment, the method comprising:
determining that a first base station is causing time of flight interference in a second coverage area served by a second base station; and
based on said determination, communicating a codebook subset restriction (CBSR) to a user equipment (UE) served by the first base station that comprises one or more restricted precoding matrix indicators (PMIs), wherein communicating the CBSR causes the UE to select an unrestricted PMI.

17. The non-transitory computer-readable media of claim 16, wherein determining that the first base station is causing time of flight interference is based on an interference level measured at the second base station having a first value at a first time in a series of uplink slots and a second value at a second time in the series of uplink slots, the first value being greater than the second value and the first time being before the second time.

18. The non-transitory computer-readable media of claim 17, wherein the one or more restricted PMIs correspond to downlink signals transmitted along an axis having an elevation greater than a first elevation limit.

19. The non-transitory computer-readable media of claim 18, wherein the one or more restricted PMIs are within a predetermined azimuth of a line of bearing between the first base station and the second base station.

20. The non-transitory computer-readable media of claim 19, wherein the operations further comprise communicating a second CBSR to the UE comprising a second set of restricted PMIs based a determination that an interference level measured at the second base station has reduced from a first level to a second level, the second level being greater than a predetermined threshold, and wherein the second set of restricted PMIs correspond to downlink signals transmitted along an axis having an elevation greater than a second elevation limit, the second elevation limit being angled nearer to the ground than the first elevation limit.
